(19) United States
(12) Patent Application Publication
(10) Pub. No.: US 2025/0031814 A1
(43) Pub. Date: Jan. 30, 2025

(54) CYLINDER UMBRELLA LIGHT AND SUN SHADE UMBRELLA HAVING THE SAME

(71) Applicant: Linhai Zhongtian Electronic Appliance co.,ltd, Taizhou (CN)

(72) Inventor: Shimin JIN, Taizhou (CN)

(21) Appl. No.: 18/916,658

(22) Filed: Oct. 15, 2024

(51) Int. Cl. A45B 3/04; F21L 4/08; F21V 17/14; F21V 33/00; F21W 111/10; G03B 17/56; G03B 29/00

(52) U.S. Cl. CPC A45B 3/04; F21L 4/085; F21V 17/14; F21V 33/0004; G03B 29/00; A45B 2200/1018; A45B 2200/1027; F21W 2111/10; G03B 17/561

(57) ABSTRACT

A cylinder umbrella light, including an umbrella disc body and a downlight or a camera. A mounting groove is provided at a lower end of the umbrella disc body. A plurality of first limiting blocks are provided spaced apart on an inner wall of the mounting groove. The downlight or the camera is provided in the mounting groove, and is detachably connected to the mounting groove. A sun shade umbrella is further provided, which includes an umbrella body and the cylinder umbrella light. The cylinder umbrella light is fixedly disposed on the umbrella body.

### TECHNICAL FIELD

This application relates to umbrellas, and more particularly to a cylinder umbrella light and a sun shade umbrella having the same.

### BACKGROUND

In addition to the function of sun shading, some traditional sun shade umbrellas are also equipped with an electric lighting facility for illumination, which enlarges the application of the sun shade umbrella. However, the application range is still limited due to fewer functions.

For example, Chinese patent publication No. 104720227A discloses a solar shading umbrella with a storage battery on a supporting rod and an electric light under the storage battery, which can also be used for lighting while realizing sun shading. However, this solar shading umbrella only has these two functions, and the scope of application is still small.

### SUMMARY

In view of the deficiencies in the prior art, this application provides a cylinder umbrella light and a sun shade umbrella having the same, realize multiple functions of shading, lighting or monitoring.

Technical solutions of this application are described as follows.

In a first aspect, this application provides a cylinder umbrella light, comprising:
an umbrella disc body; and
a downlight or a camera;
wherein a lower end of the umbrella disc body is provided with a mounting groove; a plurality of first limiting blocks are provided spaced apart on an inner wall of the mounting groove; the downlight or the camera is provided in the mounting groove; and the downlight or the camera is detachably connected to the mounting groove.

In an embodiment, the downlight comprises a lamp panel and a fixing ring; the lamp panel is detachably mounted on the fixing ring; the fixing ring is provided with a second limiting block; and the second limiting block is configured to cooperate with the first limiting block to fix the downlight in the mounting groove.

In an embodiment, the downlight further comprises a lens; a flange is provided on an edge of the lens; the lens is configured to be clamped into an annular opening of the fixing ring through the flange; and a lower end of the lens is configured to protrude from the annular opening of the fixing ring.

In an embodiment, the fixing ring is provided with a positioning post.

In an embodiment, the camera comprises a fixing seat, a rotating seat, and a turnable lens; the fixing seat is fixedly provided with a second limiting block; the second limiting block is configured to cooperate with the first limiting block to fix the fixing seat in the mounting groove; the rotating seat is rotationally connected to the fixing seat; and the turnable lens is rotationally connected to the rotating seat. In an embodiment, the fixing seat is provided with a positioning post.

In an embodiment, a connecting member is provided at an upper end of the umbrella disc body; and the connecting member is configured to connect the umbrella disc body to an umbrella pole.

In an embodiment, an upper end of the connecting member is provided with a tapered surface.

In an embodiment, a plurality of notches are provided at an edge of the umbrella disc body; and each of the plurality of notches is provided with an articulating member.

In an embodiment, the lens is hemispherical.

In an embodiment, each of the plurality of first limiting blocks is strip-shaped; and the plurality of first limiting blocks are transversely arranged along a circumferential direction of the mounting groove.

In an embodiment, the cylinder umbrella light further comprises a battery fixedly disposed in the umbrella disc body; and a lamp panel is electrically connected to the battery.

In a second aspect, this application further provides a sun shade umbrella, comprising the cylinder umbrella light above and an umbrella body; wherein the umbrella body comprises an umbrella cloth, an umbrella pole, a plurality of umbrella ribs, and an upper umbrella disc; the umbrella disc body is hingedly connected to the plurality of umbrella ribs.

In an embodiment, the umbrella body further comprises a lower umbrella disc which is hingedly connected to the plurality of umbrella ribs; and the cylinder umbrella light is detachably connected to the lower umbrella disc.

In an embodiment, a solar photovoltaic panel is fixedly provided at a top of the umbrella body; and the solar photovoltaic panel is electrically connected to a power supply.

Compared to the prior art, this application has the following beneficial effects.
(1) A mounting groove is provided on the umbrella disc body of a cylinder umbrella light, which can realize a lighting function by installing a downlight in the mounting groove, and realize a monitoring function by installing a camera in the mounting groove. Both the downlight and the camera can be disassembled and replaced for use.
(2) The cylinder umbrella light can adjust monitoring range of the camera by driving the rotating seat and the turnable lens.

### BRIEF DESCRIPTION OF THE DRAWINGS

In order to illustrate the technical solutions in the embodiments of the present disclosure or in the prior art more clearly, the drawings required in the description of the embodiments will be briefly described below. Obviously, presented in the drawings are merely some embodiments of the present disclosure, which are not intended to limit the disclosure. For those skilled in the art, other drawings may also be obtained according to the drawings provided herein without paying creative efforts.

FIG. 1 is a schematic diagram of an assembled structure of a downlight and an umbrella disc body according to one embodiment of the present disclosure;

FIG. 2 is an exploded view of FIG. 1;

FIG. 3 is a schematic diagram of an assembled structure of a camera and an umbrella disc body according to one embodiment of the present disclosure;

FIG. 4 is an exploded view of FIG. 3; and

FIG. 5 is a schematic diagram of an assembled structure of a lower umbrella disc and an umbrella disc body according to one embodiment of the present disclosure.

In the drawings:

1, umbrella disc body; 11, mounting groove; 12, first limiting block; 13, connecting member; 131, tapered surface; 14, notch; 15, articulating member; 2, downlight; 21, lamp panel; 22, lens; 221, flange; 23, fixing ring; 24, second limiting block; 25, first positioning post; 3, camera; 31, fixing seat; 32, rotating seat; 33, turnable lens; 34, third limiting block; and 35, second positioning post.

### DETAILED DESCRIPTION OF EMBODIMENTS

The technical solutions in the embodiments of the present disclosure will be clearly and completely described below in conjunction with the accompanying drawings of the present disclosure. It is clear that described below are merely some embodiments of the disclosure, which are not intended to limit the disclosure. For those skilled in the art, other embodiments obtained based on these embodiments without paying creative efforts should fall within the scope of the disclosure.

In view of the deficiencies in the prior art, this application provides a cylinder umbrella light and a sun shade umbrella having the same, realize multiple functions of shading, lighting or monitoring.

In order to make the above objects, features and advantages of the disclosure more understandable, the disclosure will be further described in detail in conjunction with the accompanying drawings and specific embodiments.

### Embodiment 1

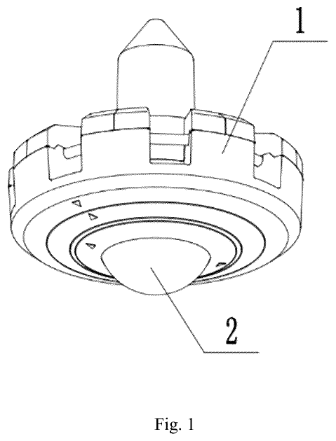

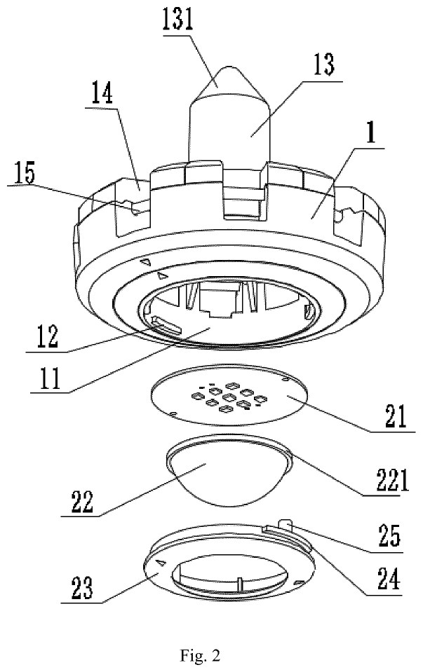

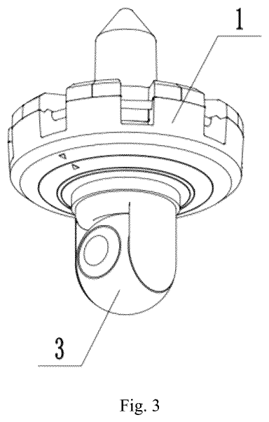

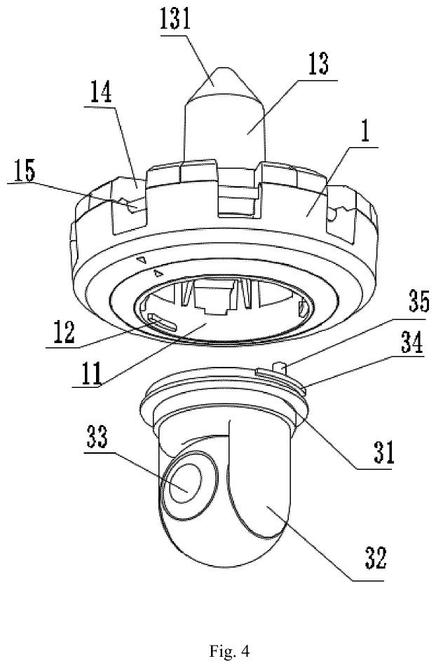

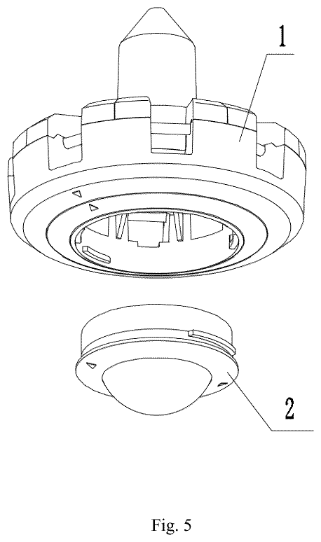

As shown in FIGS. 1-5, a cylinder umbrella light is provided. The cylinder umbrella light includes an umbrella disc body 1 and a downlight 2 or a camera 3. A mounting groove 11 is provided at a lower end of the umbrella disc body 1. A plurality of first limiting blocks 12 are provided spaced apart on the inner wall of the mounting groove 11. The downlight 2 or the camera 3 is provided in the mounting groove 11. The downlight 2 or the camera 3 is detachably connected to the mounting groove 11.

In this embodiment, the mounting groove 11 is cylindrical in shape. Each first limiting block 12 is strip-shaped. A plurality of first limiting blocks 12 are transversely arranged on the inner wall of the mounting groove 11 along a circumference direction of the mounting groove 11. A plurality of first limiting blocks 12 are arranged in a circular array on the inner wall of the mounting groove 11. The first limiting block 12 is provided with a stopper. The downlight 2 or the camera 3 is detachably disposed in the mounting groove 11. When the downlight 2 is installed in the mounting groove 11, a lighting function can be realized. When the camera 3 is installed in the mounting groove 11, a monitoring function can be realized. The camera 3 can be placed along with the cylinder umbrella light to monitor a certain range of the site. The downlight 2 and the camera 3 can be both dismountable, which helps to repair or replace the downlight 2 or the camera 3, and has various functions.

In this embodiment, the downlight 2 includes a lamp panel 21 and a fixing ring 23. The lamp panel 21 is detachably mounted on the fixing ring 23. The fixing ring 23 is provided with a second limiting block 24. The second limiting block 24 and the first limiting block 12 cooperate to fix the downlight 2 in the mounting groove 11. The fixing ring 23 is provided with a first positioning post 25.

In this embodiment, the lamp panel 21 and the fixing ring 23 are connected to form the downlight 2, so that the light emitted from the lamp panel 21 is gathered to form a light column, thereby producing better lighting effect. The second limiting block 24 is in the shape of a block or a strip. Optionally, the second limiting block 24 is in the shape of a strip. The second limiting block 24 is transversely arranged on the outer side wall of the fixing ring 23.

When installing the downlight 2, the lamp panel 21 and the fixing ring 23 are first assembled to form the downlight 2. Then, the fixing ring 23 is aligned with the mounting groove 11, and the fixing ring 23 is inserted into the mounting groove 11. The second limiting block 24 is allowed to pass through the gap between the first limiting blocks 12, so that the second limiting block 24 moves from the lower end of the first limiting block 12 to the upper end of the first limiting block 12. Then, the fixing ring 23 is rotated, thereby driving the second limiting block 24 to rotate to the top of the first limiting block 12. At this time, the first limiting block 12 will limit the second limiting block 24, and the first limiting block 12 can restrict the fixing ring 23 coming out of the mounting groove 11, thereby fixing the fixing ring 23. At the same time, the stopper on the first limiting block 12 will limit the second limiting block 24 from continuing to rotate, which can prevent the second limiting block 24 from detaching from the first limiting block 12.

When the downlight 22 needs to be disassembled, the fixing ring 23 is rotated in the opposite direction to unlock the limit of the first limiting block 12 to the second limiting block 24, thereby disassembling the fixing ring 23 from the mounting groove 11.

A first positioning post 25 is provided to position the fixing ring 23 when it is installed. Further, after the fixing ring 23 is installed, the first positioning post 25 prevents the fixing ring 23 from slipping off. Optionally, the first positioning post 25 is provided vertically, and the shape of the first positioning post 25 is cylindrical. Specifically, the first positioning post 2 is a threaded post.

In this embodiment, the cylinder umbrella light further includes a battery fixedly provided in the housing (i.e., the umbrella disc body 1). The lamp panel 21 is electrically connected to the battery, for supplying power to the lamp panel 21. Furthermore, the lamp panel 21 can be powered using the utility power through a line.

In an embodiment, the downlight 2 further includes a lens 22. The edge of the lens 22 is provided with a flange 221. The lens 22 is clamped into an annular opening of the fixing ring 23 through the flange 221. A lower end of the lens 22 is configured to protrude from the annular opening of the fixing ring 23.

In an embodiment, the lens 22 is hemispherical. By setting the lens 22, the light from LED lights on the lamp panel 21 will form a light column. When the light column is projected onto the ground, the light column will form an aperture on the ground. After the light column is refracted through the lens 22, a light ring can be formed on the ground for lighting, which has high brightness, thereby satisfying illumination needs for working and relaxing under the umbrella.

In an embodiment, the camera 3 includes a fixing seat 31, a rotating seat 32, and a turnable lens 33. The fixing seat 31 is fixedly provided with a third limiting block 34. The first limiting block 12 and the third limiting block 34 cooperates with each other to fix the fixing seat 31 in the mounting groove 11. The rotating seat 32 is rotationally connected to the fixing seat 31. The rotating seat 32 is provided with the turnable lens 33. The turnable lens 33 is rotationally connected to the rotating seat 32. The fixing seat 31 is provided with a second positioning post 35.

In an embodiment, the third limiting block 34 is in the shape of a block or a strip. For example, the third limiting block 34 is in the shape of a strip, and the third limiting block 34 is transversely disposed on the outer sidewall of the fixing ring 23. The rotating seat 32 can rotate transversely on the fixing seat 31. The turnable lens 33 can rotate longitudinally on the rotating seat 32.

When installing the camera 3, the fixing seat 31 is aligned with the mounting groove 11, and the fixing seat 31 is inserted into the mounting groove 11. The third limiting block 34 passes through the gap between the first limiting blocks 12, so that the third limiting block 34 move from the lower end of the first limiting block 12 to the upper end of the first limiting block 12. Then, the fixing seat 31 is rotated to drive the third limiting block 34 to rotate, so that the third limiting block 34 rotates to the top of the first limiting block 12. At this time, the first limiting block 12 will limit the third limiting block 34, and the first limiting block 12 can prevent the fixing seat 31 from coming out of the mounting groove 11, realizing fixing the fixing seat 31.

When the camera 3 needs to be disassembled, the fixing seat 31 is rotated in the opposite direction to unlock the limit of the first limiting block 12 from the third limiting block 34, so that the fixing seat 31 can be disassembled from the mounting groove 11.

The rotating seat 32 is rotationally connected to the fixing seat 31. The rotating seat 32 has a mounting portion. The turnable lens 33 is rotationally connected to the mounting portion. By driving the rotating seat 32 and the turnable lens 33 to rotate, it is possible to adjust the angle of the camera 3 in both the horizontal and the vertical directions, thereby realizing 360° surveillance.

A second positioning post 35 is provided to position the fixing seat 31 when the fixing seat 31 is installed. Further, after the fixing seat 31 is installed, the second positioning post 35 can prevent the fixing seat 31 from slipping off. Optionally, the second positioning post 35 is vertically disposed, and the second positioning post 35 is cylindrical.

Specifically, the second positioning post 35 is a threaded post.

In an embodiment, a connecting member 13 is provided at an upper end of the umbrella disc body 1, and the connecting member 13 is configured to connect the umbrella disc body 1 to an umbrella pole.

In an embodiment, the lower end of the connecting member 13 is connected to the umbrella disc body 1. The connecting member 13 is in the shape of a column. The cross-sectional shape of the connecting member 13 fits the shape of the umbrella pole. Optionally, the connecting member 13 is in the shape of a column. When installed, the connecting member 13 is inserted into the umbrella pole to complete installation of the umbrella disc body 1.

In an embodiment, the upper end of the connecting member 13 is provided with a tapered surface 131.

The upper end of the connecting member 13 is arranged in a tapered surface 131, facilitating the connecting member 13 inserting into the umbrella pole.

In an embodiment, a plurality of notches 14 are provided on the edge of the umbrella disc body 1, and an articulating member 15 is provided within each of the notches 14.

In an embodiment, the number of notches 14 is the same as the number of a plurality of umbrella ribs. The plurality of umbrella ribs are hinged with the articulating member 15. Optionally, the articulating member 15 is in the shape of a round rod. Two ends of the articulating member 15 are fixedly mounted on the umbrella disc body 1. The articulating member 15 is transversely arranged on the inner side of the notches 14. The end of the plurality of umbrella ribs is provided with a through-hole that is suitable for the diameter of the articulating member 15, so as to allow the articulating member 15 to pass through the through-hole so as to realize that the plurality of umbrella ribs are hinged with the articulating member 15.

### Embodiment 2

This embodiment provides a sun shade umbrella including an umbrella body and the cylinder umbrella light in Embodiment 1. The umbrella body includes an umbrella cloth, an umbrella pole, the plurality of umbrella ribs, and an upper umbrella disc. The cylinder umbrella light is hingedly connected to the plurality of umbrella ribs. The cylinder umbrella light further includes the housing, the lamp panel, the lens, and the fixing ring capable of covering the open end of the housing.

Further, the umbrella body also includes a lower umbrella disc. The lower umbrella disc is hingedly connected to the plurality of umbrella ribs. The lower umbrella disc has a clamping portion. The cylinder umbrella light can be clamped or bolted under the lower umbrella disc. The cylinder umbrella light can be disassembled.

A solar photovoltaic panel is fixedly provided on the top of the umbrella body, and a power supply can be electrically connected to the solar photovoltaic panel, and the power supply can be charged by the solar photovoltaic panel.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A cylinder umbrella light, comprising:
an umbrella disc body; and
a downlight or a camera;
wherein a lower end of the umbrella disc body is provided with a mounting groove; a plurality of first limiting blocks are provided spaced apart on an inner wall of the mounting groove; the downlight or the camera is provided in the mounting groove; and
the downlight or the camera is detachably connected to the mounting groove.

2. The cylinder umbrella light of claim 1, wherein the downlight comprises a lamp panel and a fixing ring; the lamp panel is detachably mounted on the fixing ring; the fixing ring is provided with a second limiting block; and the second limiting block is configured to cooperate with the first limiting block to fix the downlight in the mounting groove.

3. The cylinder umbrella light of claim 2, wherein the downlight further comprises a lens; a flange is provided on an edge of the lens; the lens is configured to be clamped into an annular opening of the fixing ring through the flange; and a lower end of the lens is configured to protrude from the annular opening of the fixing ring.

4. The cylinder umbrella light of claim 2, wherein the fixing ring is provided with a positioning post.

5. The cylinder umbrella light of claim 1, wherein the camera comprises a fixing seat, a rotating seat, and a turnable lens; the fixing seat is fixedly provided with a second limiting block; the second limiting block is configured to cooperate with the first limiting block to fix the fixing seat in the mounting groove; the rotating seat is rotationally connected to the fixing seat; and the turnable lens is rotationally connected to the rotating seat.

6. The cylinder umbrella light of claim 5, wherein the fixing seat is provided with a positioning post.

7. The cylinder umbrella light of claim 1, wherein a connecting member is provided at an upper end of the umbrella disc body; and the connecting member is configured to connect the umbrella disc body to an umbrella pole.

8. The cylinder umbrella light of claim 7, wherein an upper end of the connecting member is provided with a tapered surface.

9. The cylinder umbrella light of claim 1, wherein a plurality of notches are provided at an edge of the umbrella disc body; and each of the plurality of notches is provided with an articulating member.

10. The cylinder umbrella light of claim 3, wherein the lens is hemispherical.

11. The cylinder umbrella light of claim 1, wherein each of the plurality of first limiting blocks is strip-shaped; and the plurality of first limiting blocks are transversely arranged along a circumferential direction of the mounting groove.

12. The cylinder umbrella light of claim 3, further comprising:
a battery fixedly disposed in the umbrella disc body;
wherein the lamp panel is electrically connected to the battery.

13. A sun shade umbrella, comprising:
the cylinder umbrella light of claim 1; and
an umbrella body;
wherein the umbrella body comprises an umbrella cloth, an umbrella pole, a plurality of umbrella ribs, and an upper umbrella disc; the umbrella disc body is hingedly connected to the plurality of umbrella ribs.

14. The sun shade umbrella of claim 13, wherein the umbrella body further comprises a lower umbrella disc which is hingedly connected to the plurality of umbrella ribs; and the cylinder umbrella light is detachably connected to the lower umbrella disc.

15. The sun shade umbrella of claim 13, wherein a solar photovoltaic panel is fixedly provided at a top of the umbrella body; and the solar photovoltaic panel is electrically connected to a power supply.
